(19) United States
(12) Patent Application Publication
(10) Pub. No.: US 2005/0279939 A1
(43) Pub. Date: Dec. 22, 2005

(54) Infrared detection element, infrared detector, solid state imaging device, and method for fabricating infrared detector

(75) Inventors: Shinji Yoshida, Osaka (JP); Masanori Okuyama, Osaka (JP); Minoru Noda, Osaka (JP); Daniel Popovici, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/059,507

(22) Filed: Feb. 17, 2005

(30) Foreign Application Priority Data
Jun. 21, 2004 (JP) 2004-182490

(51) Int. Cl. G01J 5/20

(52) U.S. Cl. 250/332

(57) ABSTRACT

An infrared detection film of which a dielectric constant is changed according to a temperature change is characterized in that the infrared detection film has a composition expressed by Ba(Ti₁₋ₓSnₓ)O₃ (0<x<1) and change in the dielectric constant for temperature change of 1° C. is 2% or more. Furthermore, the Sn composition x is not less than 0.1 and not more than 0.2 and the thickness of the infrared detection film is 2 μm or less. With a dielectric bolometer including the infrared detection film, a highly sensitive infrared detector or solid imaging device which is operable at room temperature can be achieved.

### CROSS-REFERENCE TO RELATED APPLICATION

This application claims priority under 35 U.S.C. §119(a) on Japanese Patent Application No. 2004-182490 filed on Jun. 21, 2004, the entire contents of which are hereby incorporated by reference.

### BACKGROUND OF THE INVENTION

1. Field of the Invention

The present invention relates to a thermal infrared detector including an oxide thin film for a dielectric bolometer, a method for fabricating the same, and a thermal infrared solid-state imaging device including the thermal infrared detector and used for a surveillance camera and the like.

2. Prior Art

There are many methods for detecting infrared radiation, and mainstream of infrared detectors can be categorized to two types. One of them is a group of quantum infrared detectors which is a type of detecting photoelectric signals directly produced by absorption of infrared radiation of a detection material. The other is a thermal infrared detector. This is a type of detecting changes of physical properties which is induced by an increase of temperature of the material after absorption of infrared radiation. With a quantum infrared detector, the photoelectric effect based on change in solid state due to infrared absorption is the basic principle of infrared detection. Therefore, an imaging region normally has to be cooled down by liquid nitrogen or the like. On the other hand, the thermal infrared detector uses heat generated by absorption of infrared radiation and thus infrared radiation can be detected even at room temperature.

In recent years, demands for an infrared detector and an infrared imaging device which can sense an object even in a dark field environment and, furthermore, recognize the object as an image has increased in the filed of security and prevention of crime. Specifically, compared to the quantum infrared detector, demands for a small-size, inexpensive thermal infrared imaging device keeps on increasing. The thermal infrared imaging device, which has been fabricated in silicon processes and in which pixels are arranged in a two-dimensional manner, can be advantageously formed on one chip with peripheral circuits, and therefore draws attentions as an image input device such as a small-size surveillance camera and a night version camera equipped to an automobile. Many detection principles applicable to the thermal infrared imaging device have been proposed. Especially, a pyroelectric infrared imaging device detecting polarization changes induced by a phase transition of a ferroelectric material has been expected to be a more practicable. For example, a pyroelectric infrared image sensor using a ferroelectric material such as barium strontium titanate (Br₁₋ₓSrₓTiO₃: BST) for infrared detection is disclosed in U.S. Pat. No. 4,143,269 entitled “Ferroelectric Imaging System” and U.S. Pat. No. 5,047,644 entitled “Polyimide Thermal Isolation Mesa for a Thermal Imaging System”.

However, the pyroelectric infrared image sensor is not suitable for size reduction because a chopper for modulating incident infrared radiation to a device and a thickness of a ferroelectric material has to be several μm or more to maintain high pyroelectricity. Moreover, a method for fabricating a pyroelectric infrared image sensor is complex, and thus reduction in yield has been concerned.

To cope with the problems described above, in recent years, a dielectric bolometer which can sense infrared radiation using a change in a relative dielectric constant according to temperature change has been proposed and such a dielectric bolometer exhibits excellent features such as not requiring a chopper and being suitable for size reduction. Therefore, practical use of the dielectric bolometer is expected.

In the properties of a material for a dielectric bolometer, one of the most important factors to determine the figure merit of a dielectric bolometer is temperature coefficient of dielectric (TCD) which is defined as the rate of change in relative dielectric constant with respect to temperature change. In order to achieve an infrared detector with high sensitivity, large TCD is needed and a leakage current must be small. Specifically, TCD is one of the most important factors for controlling noise equivalent of temperature difference (NETD), i.e., a temperature resolution of an infrared detector. Therefore, there have been vigorous studies for properties of materials for the purpose of achieving a large TCD and a method for fabricating an infrared detector using a dielectric film with a large TCD. A device structure of a dielectric bolometer is disclosed in, for example, Japanese Laid-Open Publication No. 11-148868 and Japanese Laid-Open Publication No. 11-271141. An oxide film for a dielectric bolometer is disclosed in, for example, Japanese Laid-Open Publication No. 11-271142, and a method for fabricating an oxide film for a dielectric bolometer is proposed in Japanese Laid-Open Publication No. 2002-124708.

### SUMMARY OF THE INVENTION

However, in any one of the techniques described above, TCD, i.e., a performance index for a dielectric film is small for achieving an infrared detector having sufficient detection ability. Thus, as a detection element of an infrared image sensor, a dielectric material with a large TCD is required.

Moreover, in terms of yield and the recent size reduction trend from manufacturing point of view, a thinner dielectric film for a dielectric bolometer is more appreciated and the thickness of a dielectric film is desired to be 2 μm or less at most. Currently, materials of the barium strontium titanate system have been vigorously studied as candidates of a thin film for a dielectric bolometer. However, sensitivity of materials of the barium strontium titanate system is low and there have not been yet prospects for practical use of such materials. One of the reasons why a material with a desired TCD is difficult to obtain will be hereafter described.

In general, it has been known that a dielectric constant is largely changed around the Curie temperature where a phase transition from a ferroelectric to a paraelectric occurs. This phenomenon is called dielectric anomaly. A dielectric bolometer uses this dielectric anomaly based on a ferroelectric-paraelectric phase transition of a ferroelectric material, and as for bulk solids, there have been reports on materials with a sufficiently large TCD. However, when the thickness of a ferroelectric is reduced, a dielectric anomaly is reduced. This means that the rate of change in the relative dielectric constant according to temperature change decreases. Specifically, the dielectric anomaly is a phenomenon which is markedly observed in a bulk state and, in general, when the thickness of a ferroelectric is reduced, the Curie temperature is shifted, the dielectric anomaly is reduced, and only monotonous change is exhibited.

FIG. 8 is a graph showing the relationship between change in relative dielectric constant according to temperature change and film thickness in Ba₁₋ₓSrₓTiO₃ (0<x<1) (which will be herein referred to as “BST”). As shown in FIG. 8, when a film thickness is 5 μm, the dielectric constant of BST shows a maximal value around 23° C. When the dielectric constant is maximal, the rate of change in the relative dielectric constant according to temperature change is −10%/K around 25° C., which exhibits a typical dielectric anomaly. In contrast, when a film thickness is 0.08 μm, the rate of change in the relative dielectric constant according to temperature change for BST is very small, i.e.,—0.2%/K around 25° C., which exhibits a small dielectric anomaly.

In this manner, as the film thickness of a dielectric is reduced, the dielectric anomaly is remarkably reduced. Therefore, a thin film having a thickness of several μm or less is not suitable for a material for an infrared detection element, and a bulk solid of a dielectric or a thick film is used for a dielectric bolometer and a pyroelectric IR sensor. Note that reduction in the dielectric anomaly with reduction in the thickness of a dielectric film has been known as the thin film effect or the size effect, but its detail mechanism has not yet clearly understood.

Use of a bulk solid or a material of a thick film as a dielectric bolometer causes low yield and high costs, and also becomes a big obstacle for reduction in an element size, as has been described. Therefore, it has been essential to develop a material for a thin film for a dielectric bolometer with a large TCD in fabricating an infrared detector using a dielectric bolometer.

Therefore, it is an object of the present invention to provide an oxide thin film for a dielectric bolometer which has a sufficiently large TCD for putting the dielectric bolometer into practical use, an infrared solid imaging device such as an infrared camera using the oxide thin film for a dielectric bolometer, and a method for forming the oxide thin film for a dielectric bolometer.

An infrared detection element in the present invention is formed of an infrared detection film of which a relative dielectric constant is changed according to temperature change. The infrared detection element is formed of Ba(Ti₁₋ₓSnₓ)O₃ (where 0<x<1) and an absolute value of the rate of change in the relative dielectric constant for temperature change of 1° C. is 2% or more at an arbitrary temperature.

Thus, using the infrared detection element of the present invention, for example, a highly sensitive infrared detector or thermal solid state imaging device which detects temperature change caused by received infrared radiation can be achieved.

If Sn composition ratio x is not less than 0.1 and not more than 0.2, the absolute value of the rate of change in the relative dielectric constant according to temperature change can be preferably made to be a proper value for achieving an infrared detector and a thermal solid state imaging device.

Specifically, it is more preferable that Sn composition x is not less than 0.13 and not more than 0.16.

Moreover, if the infrared detection film has a thickness of 2 μm or less, a dielectric bolometer of which a yield is increased and the size is reduced can be formed. Thus, a thermal solid state imaging device using the dielectric bolometer can be achieved.

An infrared detection device in the present invention includes: a first capacitor element which includes a lower electrode provided on a substrate, a dielectric film provided on the lower electrode, and an upper electrode provided on the dielectric film and of which an electrostatic capacitance value is changed according to temperature change. In the infrared detection device, the dielectric film is formed of Ba(Ti₁₋ₓSnₓ)O₃ (where 0<x<1).

Thus, a highly sensitive thermal infrared detector and infrared solid state imaging device which are operable at room temperature can be fabricated.

It is preferable that Sn composition ratio x is not less than 0.1 and not more than 0.2.

If the infrared detection device further includes a second capacitor element connected to the first capacitor element in series and detects a potential between the first capacitor element and the second capacitor element, the infrared detection device can sense infrared radiation at high sensitivity.

A solid state imaging device according to the present invention is a solid state imaging device including: a substrate in which an imaging region is formed; and pixels arranged in a one- or two-dimensional manner each for sensing infrared radiation received from the outside, thereby generating a signal, wherein each of the pixels includes a first capacitor element which has a dielectric film formed of Ba(Ti₁₋ₓSnₓ)O₃ (where 0<x<1) and of which an electrostatic capacitance value is changed according to an amount of the received infrared radiation at an arbitrary temperature.

With this configuration, the electrostatic capacitance of the first capacitor element is largely changed according to the amount of received infrared radiation. Thus, by sensing change in a potential due to the change in the electrostatic capacitance, a finer and higher quality image can be captured than that in the known technique. Moreover, with this configuration, an imaging device with an increased number of pixels can be achieved and infrared image of a subject can be captured as either a still image or a moving picture.

It is preferable that Sn composition ratio x is not less than 0.1 and not more than 0.2.

It is preferable that the dielectric film has a thickness of 2 μm or less.

A method for fabricating an infrared detector according to the present invention is a method for fabricating an infrared detector including a capacitor element which has a lower electrode formed on a substrate, a dielectric film formed of Ba(Ti₁₋ₓSnₓ)O₃ (where 0<x<1) on the lower electrode by metal organic decomposition and an upper electrode formed on the dielectric film and of which an electrostatic capacitor value is changed according to temperature change, wherein the step of forming the dielectric film comprises the steps of: spin coating for depositing Ba(Ti₁₋ₓSnₓ)O₃ using an orgametallic compound; drying for evaporating an organic solvent by performing heat treatment to the substrate; pre-baking for generating a crystal nuclear of Ba(Ti₁₋ₓSnₓ)O₃ by performing heat treatment to the substrate; and main baking for growing a crystal from the crystal nuclear by performing heat treatment to the substrate.

According to the method, the mixture ratio of each element in a material for a dielectric film can be accurately controlled and a uniform dielectric film can be formed. Moreover, the dielectric film can be formed at relatively low costs.

It is preferable that the step of spin coating is performed in a nitrogen atmosphere.

It is preferable that in the step of drying, heat treatment is performed to the substrate at a lower temperature than a crystallization temperature of Ba(Ti₁₋ₓSnₓ)O₃.

It is preferable that in the step of drying, the substrate is heated from a back surface side of the substrate.

If the method further includes the step of post-drying treatment for heating the substrate at a lower temperature than a crystallization temperature of Ba(Ti₁₋ₓSnₓ)O₃ after the step of drying and before the step of pre-baking, a larger TCD can be preferably obtained, compared to the case where post-drying treatment is not performed.

In the method for fabricating an infrared detector, the step of baking is performed at a higher temperature than a processing temperature of the pre-baking, i.e., a temperature of not less than 600° C. and not more than 1000° C.

It is preferable that the step of pre-baking is performed in a vapor phase containing oxygen.

It is preferable that the step of baking is performed in a vapor phase containing oxygen.

If the method further includes the step of post-annealing for performing heat treatment to the dielectric film and the upper electrode at a temperature of 500° C. or less in a vapor phase containing oxygen, the absolute value of TCD for the dielectric film can be increased.

### BRIEF DESCRIPTION OF THE DRAWINGS

FIG. 1 is a graph showing change in relative dielectric constant according to temperature change for an infrared detection film formed of BTS according to a first embodiment of the present invention.

FIG. 2 is a graph showing change in relative dielectric constant according to temperature change for bulk BTS in the case where the composition ratio of Sn contained in BTS is in a range from 0 to 0.16.

FIG. 3 is a diagram illustrating an exemplary configuration of a dielectric bolometer infrared solid state imaging device according to a second embodiment of the present invention.

FIG. 4 is a diagram schematically illustrating a read-out circuit provided in a pixel in a solid state imaging device of the second embodiment.

FIG. 5 is a flow chart illustrating respective steps for fabricating a BTS film using MOD.

FIG. 6 is a graph showing results of differential thermal analysis (DTA) and thermogravimetric analysis (TG) for BTS when the Sn composition ratio was 0.15.

FIG. 7 is a graph showing dependency of TCD of a BTS15 film according to the present invention on temperature and effects of post-annealing.

FIG. 8 is graph showing the relationship between change in relative dielectric constant according to temperature change and film thickness in BST (Ba₁₋ₓSrₓTiO₃).

### DESCRIPTION OF THE PREFERRED EMBODIMENTS

### First Embodiment

An infrared detection film (infrared detection element) according to a first embodiment of the present invention is a material of which a relative dielectric constant is changed due to change in temperature caused by incident infrared light and is also a dielectric bolometer oxide thin film expressed by a chemical formula of Ba(Ti₁₋ₓSnₓ)O₃ (0<x<1) (which will be herein referred to as “BTS”). A material for the infrared detection film of this embodiment is a ferroelectric expressed by Ba(Ti₁₋ₓSnₓ)O₃ (0<x<1) obtained by replacing part of titanium atoms of barium titanate expressed by the chemical formula of BaTiO₃ with tin atoms and the Sn composition ratio x in BTS is not less than 0.1 and not more than 0.2. Specifically, the infrared detection film of this embodiment is, for example, a dielectric film of Ba(Ti₁₋ₓSnₓ)O₃ (0.10≧x≧0.20) formed on a lower electrode made of platinum (Pt) formed over a silicon substrate, and having a thickness of 2 μm or less. An absolute value of temperature coefficient of dielectric (TCD) is 2% or more. TCD indicates the rate of change in relative dielectric constant according to temperature change for the infrared detection film of this embodiment as a phase transition from a ferroelectric to a paraelectric occurs at room temperature (25° C.). Note that in this embodiment, the Sn composition ratio is x in the above-described chemical formula expressing BTS.

In the infrared detection film of this embodiment, when the Sn composition ratio in BTS is not less than 0.1 and not more than 0.2, the absolute value of TCD shows a large value, i.e., 2% or more, regardless that the infrared detection film has a thickness of 2 μm or less. As has been described, reduction in dielectric anomaly when the thickness of the dielectric film is reduced is one of the most significant factors which have made it difficult to achieve a dielectric bolometer infrared sensor using a dielectric thin film. However, even when the infrared detection film of this embodiment has a reduced thickness, the rate of change in the relative dielectric constant according to temperature change is kept to be large. Therefore, the infrared detection film can be used as a material for a dielectric bolometer which allows achievement of a highly sensitive, fine infrared detection device. Herein, the present inventors have confirmed that if the absolute value of TCD is 2% or more for an infrared detection film, the infrared detection film in an infrared detector or an imaging device can be put into practical use.

Next, results of experiments conducted by the present inventors to form an infrared detection film having the above-described composition will be described.

First, the present inventors have conducted an experiment to examine use of BTS as a material for an infrared detection film. This experiment has been conducted because a BTS film with excellent quality can be formed by MOD spin coating described later and the like. Thus, the present inventors focused on the fact that the composition ratio of Sn (tin) with which titanium atoms are replaced is one of important factors for determining TCD and a Curie temperature for BTS and then examined the Sn composition ratio at which the absolute value of TCD becomes large.

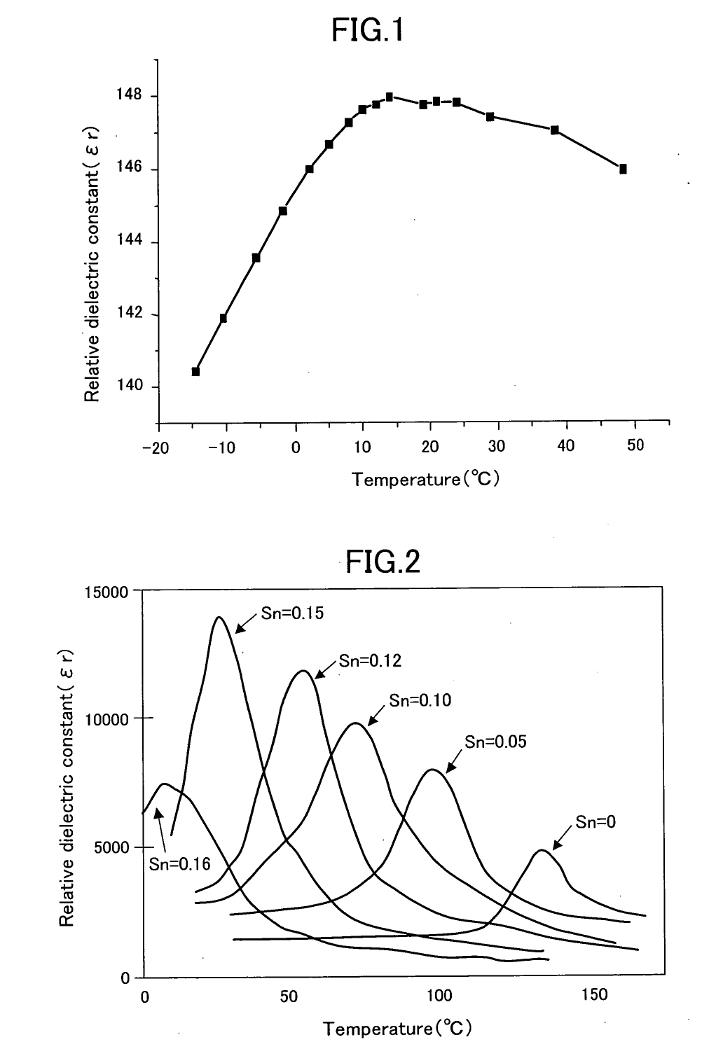

FIG. 1 is a graph showing the rate of change in the relative dielectric constant according to temperature change for an infrared detection film formed of BTS according to this embodiment. FIG. 2 is a graph showing change in the relative dielectric constant according to temperature change for bulk BTS when the composition ratio of Sn contained in BTS is in the range from 0 to 0.16. Note that the thickness of a BTS film used in the experiment of FIG. 1 was 0.5 μm and the Sn composition ratio is 0.15. Ba(Ti_{0.85}Sn_{0.15})O₃ will be herein referred to as “BTS15”. Moreover, TCD is the rate of change in the relative dielectric constant according to temperature change and corresponds to a derivative of the relationship between the relative dielectric constant and temperature shown in FIG. 2.

As a result of the above-described experiment, as shown in FIG. 2, it has been confirmed that when the Sn composition ratio in BTS is in the range from 0 to 0.15, the Curie temperature is shifted toward the low temperature side with increase in the Sn composition ratio and a maximal value of the relative dielectric constant is increased. Moreover, it has been also found that when the Sn composition ratio is 0.15, the maximal value of the relative dielectric constant is the largest and the absolute value of TCD at a temperature which is around the Curie temperature and is higher than the Curie temperature is the largest among examined materials. Furthermore, surprisingly, it has been also found that when the Sn composition ratio exceeds 0.16, the maximal value of the relative dielectric constant is abruptly reduced and thus the rate of change in the relative dielectric constant according to temperature change is also reduced. This tendency is considered to be the same with respect to a thin film. Therefore, it is concluded that since a large TCD has to be obtained at room temperature when a BTS film is used for an infrared detection film as a ferroelectric bolometer, the Sn composition in BTS has to be at least not less than 0.1 and not more than 0.2, and more preferably not less than 0.13 and not more than 0.16.

Furthermore, as shown in FIG. 1, it has been confirmed that the relative dielectric constant of BTS15 exhibits a typical dielectric anomaly phenomenon that the relative dielectric constant is abruptly increased with increase in temperature at a lower temperature than the Curie temperature (i.e., around a temperature at which the relative dielectric constant is maximum) and the relative dielectric constant is reduced with increase in temperature at a higher temperature than the Curie temperature. In general, it is known that such a large value of the rate of change in the relative dielectric constant according to temperature change is hardly observed in a thin ferroelectric film. However, the infrared detection film of this embodiment exhibits a marked dielectric anomaly even if the infrared detection film has a thickness of 2 μm or less. Moreover, the absolute value of TCD in BTS15 at a higher temperature than the Curie temperature is at least 2% or more. Therefore, with a dielectric bolometer using the infrared detection film of this embodiment, an infrared detector having enough sensitivity for practical use can be fabricated.

Note that the thickness of the infrared detection film of this embodiment led by the above-described results is preferable 2 μm or less. However, when a higher TCD is required or when the infrared detection film is used without keen interest in size reduction, the thickness of the infrared detection film is not particularly limited.

Moreover, it has been described that the absolute value of TCD of the infrared detection film of this embodiment at room temperature is 2% or more. Therefore, a small-size solid state imaging device or infrared detector which does not require a cooling device can be achieved. The temperature condition for this absolute value of TCD is not limited to room temperature and it is preferable that the absolute value is 2% or more at an outside-air temperature (e.g., not less than 10° C. and not more than 40° C.). If the absolute value of TCD is 2% or more at either one of room temperature or the outside-air temperature, a highly sensitive solid state imaging device or infrared detector can be achieved.

### Second Embodiment

As a second embodiment of the present invention, a solid state imaging device including a dielectric bolometer having the infrared detection film of the first embodiment which is formed of Ba(Ti₁₋ₓSnₓ)O₃ (0<x<1) will be described. The solid state imaging device of this embodiment is a dielectric bolometer thermal infrared imaging device which reads out change in a relative dielectric constant of a material according to temperature change due to incident infrared radiation as a signal indicating the intensity of the incident infrared radiation. Moreover, the solid state imaging device of this embodiment is characterized by including unit pixels each having the infrared detection film of the first embodiment, and having a structure in which the unit pixels are arranged in the one- or two-dimensional manner.

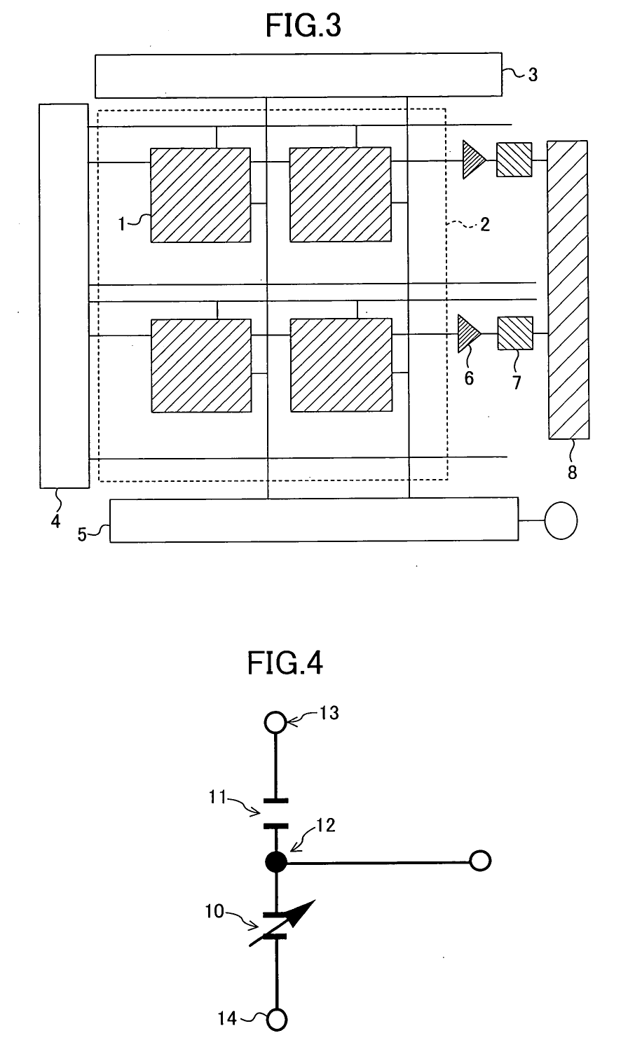

FIG. 3 is a diagram illustrating an exemplary configuration of the dielectric bolometer thermal infrared solid state imaging device of this embodiment.

As shown in FIG. 3, the solid state imaging device of this embodiment includes a semiconductor substrate (not shown) in which an imaging region 2 is formed, a plurality of pixels 1, provided in the imaging region 2 of the semiconductor substrate so as to be arranged in the two-dimensional manner, each for receiving infrared radiation, a vertical shift resistor 3 for selecting ones of the pixels 1 arranged in a first direction (a longitudinal direction in the example of FIG. 3), a horizontal shift resistor 4 for selecting ones of the pixels 1 arranged in a second direction which is a different direction from the first direction (a lateral direction in the example of FIG. 3), a timing generator 5 for supplying a necessary pulse for the vertical shift resistor 3 and the horizontal shift resistor 4, an operational amplifier 6 for amplifying a signal from each of the selected pixels 1, a band pass filter 7, provided so as to correspond to each sensor array, for removing high-frequency noise of a signal from the operational amplifier 6, and a multiplexer 8 for selectively giving a signal from the band pass filter 7 to an output terminal.

In the imaging region 2, each of the pixels 1 includes an infrared detection section, a read-out circuit and a reference capacitor. With this configuration, a highly sensitive thermal infrared solid state imaging device can be achieved.

FIG. 4 is a diagram illustrating an exemplary read-out circuit (a dielectric bolometer, i.e., an infrared detector) provided in the pixel 1 in the solid state imaging device of this embodiment. As shown in FIG. 4, the read-out circuit has an infrared detection capacitor (first capacitor element) 10 including an infrared detection film formed of a BTS film of which a relative dielectric constant is changed according to temperature change, and a reference capacitor (second capacitor element) 11 including a BTS film having the same composition and thickness as those of the infrared detection capacitor 10. Moreover, a first end 13 is connected to the reference capacitor 11 and a second end 14 is connected to the infrared detection capacitor 10. Then, the infrared detection capacitor 10 includes a first electrode (lower electrode) and a second electrode (upper electrode) each provided on the substrate and a BTS film interposed between the first and second electrodes, and an electrostatic capacitance value is changed according to temperature change. Moreover, the reference capacitor 11 includes a third electrode and a fourth electrode and a BTS film interposed between the third and fourth electrodes. In this case, the Sn composition ratio in each of the BTS films is not less than 0.1 and not more than 0.2.

Moreover, the infrared detection capacitor 10 is heat-insulated from the surrounding and a capacitance value is changed according to temperature change due to incidence of infrared radiation. Specifically, when infrared radiation at a higher temperature than the Curie temperature of each of the BTS films is injected and the temperature of each of the BTS films is increased, the relative dielectric constant of each of the BTS films is reduced, so that the capacitance of the infrared detection capacitor 10 is reduced. On the other hand, the reference capacitor 11 is disposed on the substrate and the temperature thereof is hardly changed due to incidence of infrared radiation. Therefore, the capacitance of the reference capacitor 11 is hardly changed.

In the configuration described above, by applying an alternating current voltage between the first end 13 and the second end 14 to apply the alternating current voltage to the infrared detection capacitor 10 and the reference capacitor 11, a potential of an intermediate node between the two capacitances can be read out. In this case, the intermediate node 12 is provided between the infrared detection capacitor 10 and the reference capacitor 11.

Moreover, in the solid state imaging device of this embodiment, the temperature of the infrared detection section (infrared detection capacitor 10) is preferably kept constant. Specifically, it is more preferable in terms of a sensor to keep the infrared detection section from being directly influenced by change in an outside-air temperature. As can be seen from FIGS. 1 and 2, TCD, which indicates the rate of change in the relative dielectric constant with respect to temperature change, shows a large absolute value at a temperature of the Curie temperature at which a dielectric anomaly is caused. In contrast, TCD shows a small absolute value at a temperature at which the relative dielectric constant is the maximum or in a temperature range in which the rate of change in the relative dielectric constant is reduced. Therefore, to use BTS as an infrared detection material, it is required to set the temperature of the bolometer thin film by an appropriate temperature-compensating device so that the absolute value of TCD becomes a maximum. With this configuration, infrared radiation can be detected in a temperature at which TCD shows the maximum value all the time. Therefore, sensitivity of the infrared detector is improved.

As has been described, by using the infrared detection film of the present invention, a thermal infrared solid state imaging device or an infrared sensor which is highly sensitive and of which the size can be made smaller, compared to the known device, can be achieved. More specifically, if the dielectric bolometer including the infrared detection film of the present invention is used, a medical device such as a thermometer and a thermography, an indoor security sensor, a resource exploration system, or a monitoring camera for a manufacturing facility, which all are small-sized and usable at room temperature, can be achieved.

### Third Embodiment

As a third embodiment of the present invention, a method for fabricating an infrared detection film (a dielectric bolometer thin film, i.e., an infrared detection element) in a composition expressed by Ba(Ti₁₋ₓSnₓ)O₃ (0<x<1) will be described. In the method of this embodiment, a BTS film is formed using metal organic decomposition (MOD). MOD has mainly the following four advantages: (1) accurate stoichiometry control can be performed; (2) excellent uniformity in film formation can be achieved; (3) MOD is suitable for formation of a film with a large area; and (4) fabrication device and method are low-cost and very simple. Because of the four advantages described above, MOD can be adopted to a method for fabricating a BTS film, so that a BTS thin film having a large TCD can be formed at low cost and in a relatively simple manner.

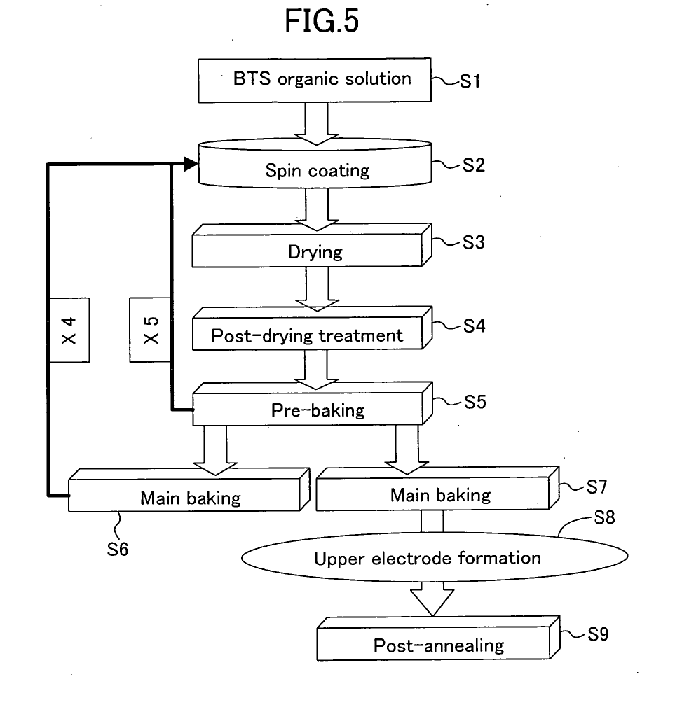

FIG. 5 is a flow chart showing respective steps for fabricating a BTS film using MOD.

Normal MOD includes mainly four different process steps. First, in Step S2 of FIG. 5, a solution obtained by dissolving an organometallic complex is mixed at a predetermined mol ratio and then the solution is uniformly applied over a substrate by spin coating. Note that when the infrared detection capacitor 10 of FIG. 4, a lower electrode made of platinum (Pt) is formed on the substrate by sputtering or the like in advance. Then, a BTS film is formed on the lower electrode.

Next, in Step S3, drying, i.e., heat treatment for decomposing or evaporating the organic solvent is performed. The heat treatment of drying has to be performed at a lower temperature than a crystallization temperature of a dielectric to be formed.

Next, after post-drying treatment has been performed in Step S4, in Step S5, low-temperature baking (referred to as pre-baking) for generating a crystalline nuclear of a dielectric to be formed is performed onto the substrate. Subsequently, in Step S6, high-temperature baking (referred to as main baking) for growing crystals is performed.

By performing the above-described series of steps, a film having several tens nm can be formed. Thus, the series of steps are repeated to obtain a desired film thickness. Moreover, in forming a film for a dielectric bolometer, the step of forming an electrode is necessary, in addition to the above-described basic fabrication steps.

In each of the above-described steps of MOD, various process conditions such as atmosphere, temperature and time have to be set, and it is the most difficult and important in forming a material exhibiting desired properties to determine proper process conditions. A fabrication method according to the present invention is relates to a method for forming a BTS film with TCD of 2% or more at room temperature. Hereafter, detail description thereof will be described.

Spin Coating

BTS is a dielectric having a structure in which part of titanium atoms of barium titanate is replaced with tin atoms. Therefore, in spin coating, an organic solvent in which each organometallic complex is dissolved is mixed at a predetermined mol ratio. In this case, to form a BTS film with a large TCD, the mol ratio of tin in the MOD solution has to be set to be not less than 0.1 and not more than 0.2. Thus, the BTS film with a TCD of 2% or more can be obtained at room temperature. Moreover, spin coating is performed in a nitrogen atmosphere.

Drying and Post-Drying Treatment

In drying, a substrate is heated from the back surface side thereof for one minute at a temperature of 340° C. or less, e.g., at 250° C. Moreover, after this heat treatment, as a post-drying treatment, the substrate is processed again for about 10 minutes at a temperature of the crystallization temperature of the BTS film or less. The reason why this condition is adopted is as follows.

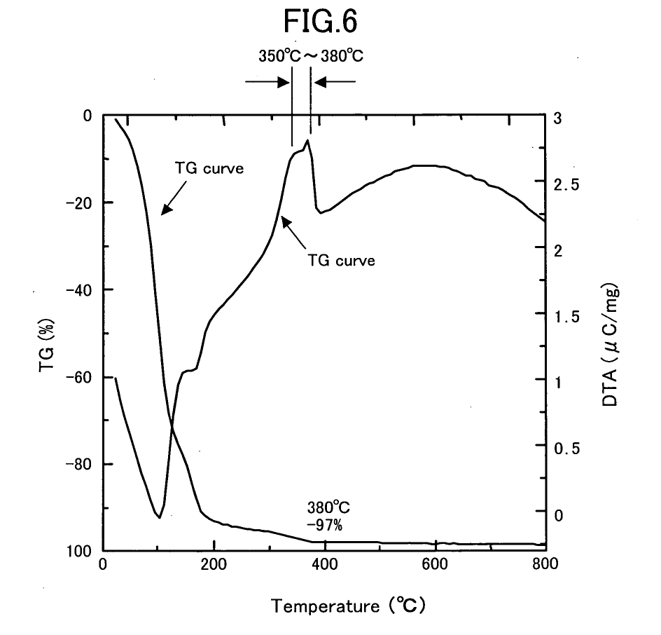

FIG. 6 is a graph showing results of differential thermal analysis (DTA) and thermogravimetric analysis (TG) for BTS when the Sn composition ratio is 0.15. Drying has to be performed at the crystallization temperature of BTS or less and, as shown in FIG. 6, from the results of DTA and TG, it has been found that the crystallization temperature of BTS is in the range from 350° C. to 380° C. This result shows that a desired heat treatment temperature in drying is 350° C. or less. Then, in this embodiment, drying is performed at 250° C. Moreover, a process time of drying depends on temperature, and thus in this embodiment, heat treatment is performed at 250° C. for one minute. In this case, the heat treatment in drying is performed using a hot plate or the like and heating is started with the back surface of the substrate, i.e., an opposite surface of the substrate to a surface of the substrate to which the organic solvent has been applied. In drying, even if a method in which the entire substrate is heated is used, a relatively large TCD can be achieved. However, in the present invention, it has been confirmed that TCD is increased furthermore by heating the substrate from the back surface of the substrate.

Furthermore, it has been also confirmed that if heat treatment at the crystallization temperature or less is performed again after drying, a BTS film with a large TCD can be achieved. This step will be herein referred to as “low-temperature heat treatment (post-drying treatment)”. The low-temperature heat treatment is not included in normal MOD. In forming a BTS film, however, a BTS film with a larger TCD could be obtained in the case where the low-temperature heat treatment was performed, compared to the case where the low-temperature heat treatment was not performed. Moreover, it has been found that in heat treatment of the low-temperature heat treatment, a large TCD can be obtained by uniformly heating the entire substrate. Then, in this embodiment, heat treatment of 250° C. is performed for 10 minutes using an oven.

Baking

In general, baking includes low-temperature baking which is called “pre-baking” and high-temperature baking which is called “main baking” and each of low-temperature baking and high-temperature baking is heat treatment at a higher temperature than the crystallization temperature. To form a BTS film with a large TCD, conditions in baking have to be set in the following manner.

Pre-baking can be performed at a higher temperature than the crystallization temperature or more. However, pre-baking is preferably heat treatment at a temperature of 360° C. or more using a furnace and more preferably heat treatment of 450° C. or more. Moreover, pre-baking is performed in an oxygen atmosphere and the flow rate of oxygen is about 1 L/min and this is a suitable condition for obtaining a large TCD. Then, a series of steps from the above-described spin coating to pre-baking are repeated for about four to five times and then main baking is performed once. Normally, through the series of steps from spin coating to main baking, a BTS film having a thickness of about 50-60 nm can be formed. To obtain a BTS film having a larger thickness, the series of steps have to be repeatedly performed. According to the present invention, as pre-baking, main baking has to be performed at a higher temperature than the crystallization temperature. In the case of baking BTS, it is preferable to perform heat treatment at not less than 600° C. and not more than 1000° C. for 10 minutes or more.

On the other hand, main baking is performed in an oxygen atmosphere using a furnace and a suitable flow rate of oxygen in the main baking is 1 L/min. To obtain a large TCD, it is essential that oxygen is present in an atmosphere.

Electrode Formation and Post-Annealing

After the above-described baking has been completed, an upper electrode is formed on the BTS film to serve as an infrared detection film.

In this step, platinum (Pt) is used as a material for an electrode. Specifically, Pt is deposited over the BTS film to a thickness of 200 nm by sputtering, thereby forming an upper electrode.

Subsequently, heat treatment to the BTS film and the upper electrode, i.e., post-annealing is performed. This step can be performed at 500° C. or less but is preferably performed at the crystallization temperature of BTS or less, i.e., a temperature of not less than 200° C. and not more than 350° C. Moreover, to improve TCD of the BTS film, post-annealing is preferably performed in an atmosphere, such as air (a mixture of nitrogen of 80% and oxygen of 20%), containing oxygen. In the method of this embodiment, a BTS film with a larger TCD than 10% can be obtained by performing post-annealing in air. Note that the above-described condition has been led from the following experiment results.

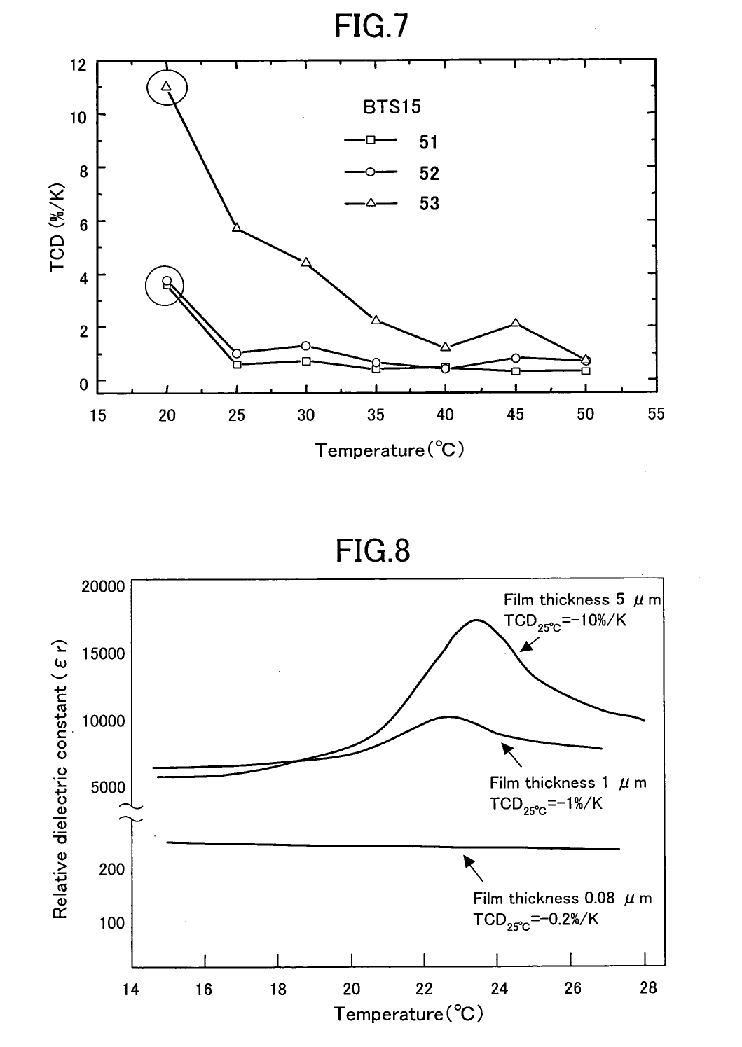

FIG. 7 is a graph showing dependency of TCD on temperature for a BTS15 film and effects of post-annealing. In this graph, the thickness of the BTS15 film is about 500 nm. A line graph 51 shows dependency of TCD on temperature for BTS15 obtained without performing post-annealing. Line graphs 52 and 53 show dependencies of TCD on temperature for BTS15 when post-annealing was performed in vacuum and when post-annealing was performed in air, respectively. As for BTS15, the largest TCD is given at 20° C.

From the results shown in FIG. 7, the dependencies of TCD on temperature when post-annealing was not performed (the line graph 51) and when post-annealing was performed (the line graph 52) in vacuum are very similar to each other. In each of the line graphs 51 and 52, TCD has a maximum value, i.e., 4% but is lower than 2% at a temperature of 25° C. or more. In contrast, when post-annealing is performed in air (the line graph 53), TCD of the BTS film shows a very large maximum value, i.e., 11% and is kept at about 2% at a temperature of 35° C. to 50° C. The detail mechanism for improving TCD by post-annealing has not clearly understood. However, it is assumed that post-annealing has the effect of repairing bindings and defects in crystal due to oxygen deficiency at an interface between an electrode and BTS.

From the results described above, it has been understood that by performing post-annealing in air, TCD of the BTS film can be increased to about 10%. Therefore, when BTS is used as an infrared detector, an infrared detector with very high sensitivity can be achieved by setting the temperature of a bolometer thin film so that TCD becomes the maximum. Specifically, according to the fabrication method of this embodiment, a BTS film with a sufficient large TCD can be obtained. Therefore, a high sensitive, very fine and low cost dielectric bolometer infrared detector or imaging device can be fabricated using the BTS film.

As has been described, the infrared detection device of the present invention is capable of sensing infrared radiation at room temperature and thus it can be used in various applications including a medical device such as a thermometer and a thermography, an indoor security sensor, and a resource exploration system. Moreover, the solid state imaging device of the present invention can be used in various applications such as a monitoring camera for security or a manufacturing facility.

1. An infrared detection element formed of an infrared detection film of which a relative dielectric constant is changed according to temperature change,
wherein the infrared detection element is formed of Ba(Ti₁₋ₓSnₓ)O₃ (where 0<x<1) and an absolute value of the rate of change in the relative dielectric constant for temperature change of 1° C. is 2% or more at an arbitrary temperature.

2. The infrared detection element of claim 1, wherein an Sn composition ratio x is not less than 0.1 and not more than 0.2.

3. The infrared detection element f claim 1, wherein an Sn composition x is not less than 0.13 and not more than 0.16.

4. The infrared detection element of claim 1, wherein the infrared detection film has a thickness of 2 μm or less.

5. An infrared detector comprising:
a first capacitor element which includes a lower electrode provided on a substrate, a dielectric film provided on the lower electrode, and an upper electrode provided on the dielectric film and of which an electrostatic capacitance value is changed according to temperature change,
wherein the dielectric film is formed of Ba(Ti₁₋ₓSnₓ)O₃ (where 0<x<1).

6. The infrared detector of claim 5, wherein an Sn composition ratio x is not less than 0.1 and not more than 0.2.

7. The infrared detector of claim 5, further comprising:
a second capacitor element connected to the first capacitor element in series; and
sensing means for sensing infrared radiation by detecting a potential between the first capacitor element and the second capacitor element.

8. A solid state imaging device comprising:
a substrate in which an imaging region is formed; and
pixels arranged in a one- or two-dimensional manner each for sensing infrared radiation received from the outside, thereby generating a signal,
wherein each of the pixels includes a first capacitor element which has a dielectric film formed of Ba(Ti₁₋ₓSnₓ)O₃ (where 0<x<1) and of which an electrostatic capacitance value is changed according to an amount of the received infrared radiation at an arbitrary temperature.

9. The solid state imaging device of claim 8, wherein an Sn composition ratio x is not less than 0.1 and not more than 0.2.

10. The solid state imaging device of claim 8, wherein the dielectric film has a thickness of 2 μm or less.

11. A method for fabricating an infrared detector including a capacitor element which has a lower electrode formed on a substrate, a dielectric film formed of Ba(Ti₁₋ₓSnₓ)O₃ (where 0<x<1) on the lower electrode by metal organic decomposition and an upper electrode formed on the dielectric film and of which an electrostatic capacitor value is changed according to temperature change,
wherein the step of forming the dielectric film comprises the steps of:
spin coating for depositing Ba(Ti₁₋ₓSnₓ)O₃ using an orgametallic compound;
drying for evaporating an organic solvent by performing heat treatment to the substrate;
pre-baking for generating a crystal nuclear of Ba(Ti₁₋ₓSnₓ)O₃ by performing heat treatment to the substrate; and
main baking for growing a crystal from the crystal nuclear by performing heat treatment to the substrate.

12. The method of claim 11, wherein the step of spin coating is performed in a nitrogen atmosphere.

13. The method of claim 11, wherein in the step of drying, heat treatment is performed to the substrate at a lower temperature than a crystallization temperature of Ba(Ti₁₋ₓSnₓ)O₃.

14. The method of claim 11, wherein in the step of drying, the substrate is heated from a back surface side of the substrate.

15. The method of claim 11, further comprising: the step of post-drying treatment for heating the substrate at a lower temperature than a crystallization temperature of Ba(Ti₁₋ₓSnₓ)O₃ after the step of drying and before the step of pre-baking.

16. The method of claim 11, wherein the step of baking is performed at a higher temperature than a processing temperature of the pre-baking, i.e., a temperature of not less than 600° C. and not more than 1000° C.

17. The method of claim 11, wherein the step of pre-baking is performed in a vapor phase containing oxygen.

18. The method of claim 11, wherein the step of baking is performed in a vapor phase containing oxygen.

19. The method of claim 11, further comprising: the step of post-annealing for performing heat treatment to the dielectric film and the upper electrode at a temperature of 500° C. or less in a vapor phase containing oxygen.
